(19) United States
(12) Patent Application Publication
(10) Pub. No.: US 2023/0279976 A1
(43) Pub. Date: Sep. 7, 2023

(54) SELF-SEALING FILL NIPPLE FOR PRESSURE REGULATOR

(71) Applicant: Pressure Specialist, Inc., Crystal Lake, IL (US)

(72) Inventor: John R. Ripkey, McHenry, IL (US)

(21) Appl. No.: 18/176,115

(22) Filed: Feb. 28, 2023

Related U.S. Application Data
(60) Provisional application No. 63/315,124, filed on Mar. 1, 2022.

(51) Int. Cl. F16L 21/02; G05D 16/04

(52) U.S. Cl. CPC F16L 21/022; G05D 16/04

(57) ABSTRACT

A self-sealing fill nipple for a pressure regulator having a fill port, includes a body having a first end having a quick connect fitting, a mid-body region and a threaded region for threadedly engaging the pressure regulator at the fill port. The threaded region extends from about an end of the body toward the mid-body region and is spaced therefrom by a gap. The threaded region has crest and root diameters. The mid-body region includes a tightening element proximal the quick connect fitting and a gap between the tightening element and the threaded region. The gap has a diameter equal to or less than the threaded region root diameter. A combination of a pressure regulator and a self-sealing fill nipple are also disclosed.

### CROSS-REFERENCE TO RELATED APPLICATION DATA

This application claims the benefit of and priority to Provisional U.S. Patent Application Ser. No. 63/315,124, filed Mar. 1, 2022, titled SELF-SEALING FILL NIPPLE FOR PRESSURE REGULATOR, the disclosure of which is incorporated herein in its entirety.

### BACKGROUND

The present disclosure relates to a fill nipple for a pressure regulator, and more particularly, to self-sealing fill nipple for a pressure regulator.

Pressure regulators are used in many fields, including in air rifles, paintball guns, industrial applications, and the transportation field. When used in air rifles and paintball guns, regulators are used to regulate or reduce the pressure from a local storage tank to the firing mechanism of the gun. Local tanks, which are typically carried by the user during the activity, can have capacities as small as 13 cubic inches to upwards of 90 cubic inches. The local tanks require periodic refilling in order to maintain availability of the powering gas, typically air, at an adequate pressure. Local tanks are refilled from a bulk storage tank that may stand about 4 feet tall and weigh as much as 160 pounds when full.

In order to facilitate refilling of the local tank, many pressure regulators include a fill nipple located on the regulator that permits attachment to a bulk storage tank (typically through a fill station). Refilling the local tank through the regulator avoids the need to disconnect and/or remove the local tank from the gun to refill the tank. Fill nipples are ported into the regulator through a threaded bore in the regulator that isolates the gun air feed path during the tank refilling operation.

One known fill nipple 1 is shown in FIGS. 1A and 1B. The nipple 1 includes a body 2 having a standard quick connect (QC) fitting 3 on one end, to which a fill hose (via a connector) is connected. The QC fitting 3 is a cylindrical projection having a circumferential recessed region 4 onto which the fill hose connector locks. The opposing end of the fill nipple 1 includes a threaded region 5 that extends from an end of the nipple 1 to an intermediate region 6 of the nipple 1. The QC fitting end 3 and the threaded end 5 are separated from one another by a portion of the nipple 1 that permits tightening the nipple 1 onto the regulator 10. In the illustrated nipple 1, the portion that permits tightening the nipple 1 has a standard hex (hexagonal) nut shape and size as indicated at 7. The thread 5 is formed in the regulator end of the nipple 1 from the end of the nipple 1 to the hex tightening region 7.

The nipple 1 includes a strut 8 and O-ring 9 positioned on the strut. The strut 8 reciprocates in the nipple 1 during filling operations to allow the flow of gas (air) through the nipple 1 and isolates or closes off flow through the nipple 1 once filling is complete. The O-ring 9 seals on a surface (not shown) interior of the nipple 1 to isolate flow. The struct 8 is, like the nipple 1, a known device.

One issue with known fill nipples is the seal of the nipple 1 to the regulator 10 due to the taper of the ⅛-27 National Pipe Thread (NPT) thread 5, which is a tapered thread. To obtain a “good” seal, the nipple 1 must have a sealing compound or tape applied and tightened beyond hand tightening using a tool, such as a wrench or deep socket to form the seal. This can be difficult in the field and can lend itself to the nipple 1 becoming loose from the regulator 10. In addition, small amounts of leakage have been known to occur at the nipple/regulator 1/10 interface during filling. Moreover, because the threading of the nipple 1 to the regulator 10 is outside of the strut 8 O-ring 9 seal, leakage can occur at the nipple/regulator 1/10 interface. Tapered ⅛-27 NPT threads 5 are subject to thread failure after removal and reinstallation, which is common for maintenance, cleaning of the strut surface and the like.

Accordingly, there is a need for a fill nipple that provides a positive seal at the nipple/regulator interface. Desirably, such a nipple can provide a gas-tight seal without the use of thread sealant compounds or tapes. More desirably still, such a nipple seals on an O-ring, and not on the nipple and regulator threads, nor with a sealing compound or tape, thus maintaining thread integrity.

### SUMMARY

In one aspect, a self-sealing fill nipple for a pressure regulator having a fill port, has a body having a first end having a quick connect fitting, a mid-body region and a threaded region for threadedly engaging the pressure regulator at the fill port. The threaded region extends from about an end of the body toward the mid-body region and is spaced from mid-body region by a gap. The threaded region has a crest diameter and a root diameter.

The mid-body region includes a tightening element proximal the quick connect fitting and a gap between the tightening element and the threaded region, the gap having a diameter equal to or less than the threaded region root diameter. In embodiments, the gap is configured for receipt of a seal, such as an O-ring seal.

The mid-body region can further include a stepped region between the tightening element and the gap. The stepped region can, for example, be circular. In embodiments, the tightening element is a hexagonal shaped region. The stepped region can have a diameter less than or equal to a distance across opposing flats of the hexagonal shaped region. In embodiments, the threaded region has a UNF thread, such as a ⅜ inch 24 UNF-2A (Unified National Fine Thread) thread.

In another aspect, is a combination of a pressure regulator having a fill port and a self-sealing fill nipple. The self-sealing fill nipple has a body having a first end having a quick connect fitting, a mid-body region and a threaded region for threaded engagement with the pressure regulator at the fill port.

The threaded region extends from about an end of the body toward the mid-body region and is spaced from the mid-body region by a gap. The threaded region has a crest diameter and a root diameter.

The mid-body region includes a tightening element proximal the quick connect fitting and a gap between the tightening element and the threaded region. The gap has a diameter equal to or less than the threaded region root diameter.

In embodiments, the combination further includes a seal on the fill nipple at the gap. The seal can be, for example, an O-ring.

The regulator can include an O-ring seat at the fill port. The O-ring seat can be a flat recessed area surrounding the fill port.

Further understanding of the present disclosure can be obtained by reference to the following detailed description in conjunction with the associated drawings, which are described briefly below.

### DESCRIPTION OF THE DRAWINGS

Various embodiments of an externally adjustable pressure regulator are disclosed as examples and are not limited by the figures of the accompanying drawings, in which like references may indicate similar elements and in which:

FIGS. 1A and 1B illustrate a known pressure regulator and fill nipple, in which FIG. 1A shows the regulator with the fill nipple partially threaded into the regulator, and FIG. 1B shows the fill nipple removed from the regulator with the strut partially extending from the nipple;

FIG. 2 is a perspective view of an embodiment of a self-sealing fill nipple;

FIGS. 3A and 3B are side views of the nipple, FIG. 3A being a sideview taken across the peaks of the tightening element and FIG. 3B being a cross-sectional view taken along the flats of the tightening element;

FIG. 4 shows the fill nipple and O-ring with the fill nipple strut (and strut O-ring);

FIG. 5 is a partially exploded view of the fill nipple, O-ring and regulator;

FIG. 6A is a side view of the regulator with the fill nipple partially threaded into the regulator body;

FIG. 6B is a side view of the regulator with the fill nipple fully threaded into the regulator body; and

FIG. 7 is a side view of a self-sealing fill nipple.

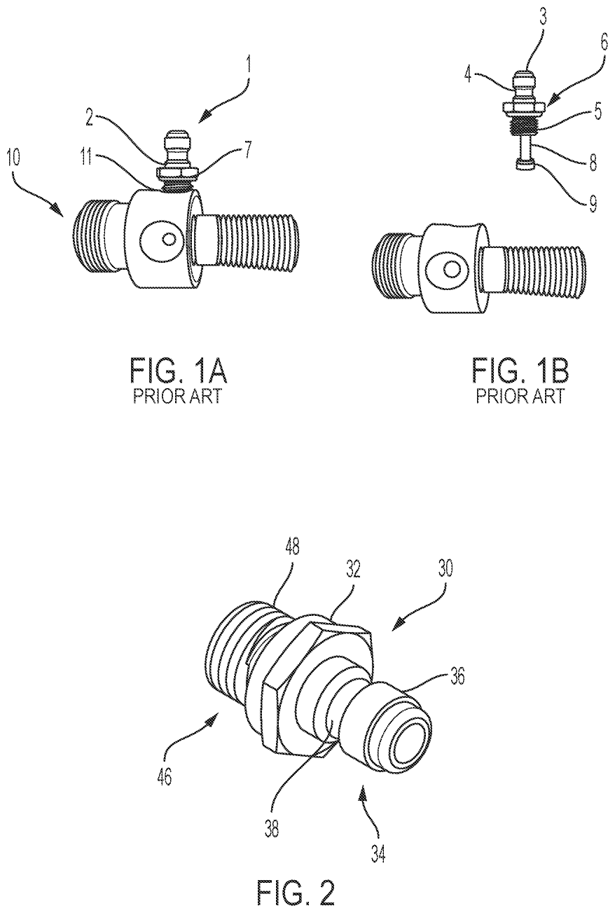

### DETAILED DESCRIPTION

While the present disclosure is susceptible of embodiments in various forms, there is shown in the drawings and will hereinafter be described a presently preferred embodiment with the understanding that the present disclosure is to be considered an exemplification and is not intended to limit the disclosure to the specific embodiment illustrated.

Referring to the figures, a pressure regulator 20 is used to regulate or reduce the pressure from a source to a device. In the context of paintball guns, the regulator 20 supplies and regulates air from a local storage tank to the firing mechanism of the gun. An example of a pressure regulator is disclosed and described in detail in Carroll, U.S. Pat. No. 7,059,343, the disclosure of which is incorporated herein by reference.

The regulator 20 includes a high pressure inlet 22 and a regulated pressure outlet 24. Various ports 26 on the regulator 20 provide for, for example, inlet and regulated pressure gauges. As discussed above, the regulator 20 permits filling a local tank (as worn by a user during paintball activities) from a bulk storage tank, without removing the local tank or regulator 20 from the paintball gun. The is accomplished through a fill port 28 that isolates the regulated side of the regulator 20 from the bulk storage tank. The local tank, paintball gun and bulk storage tank are well known components and as such are not shown.

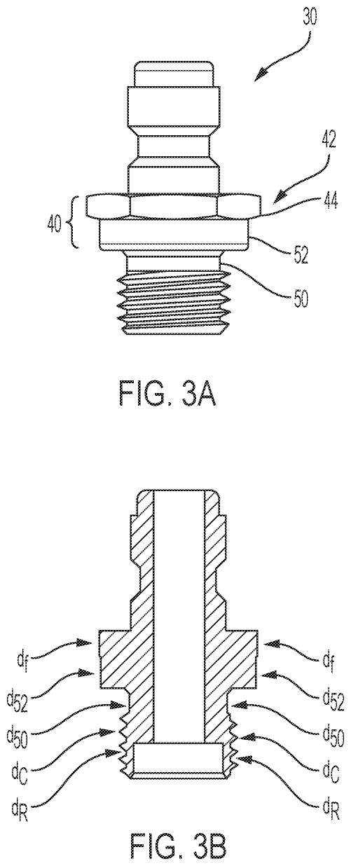

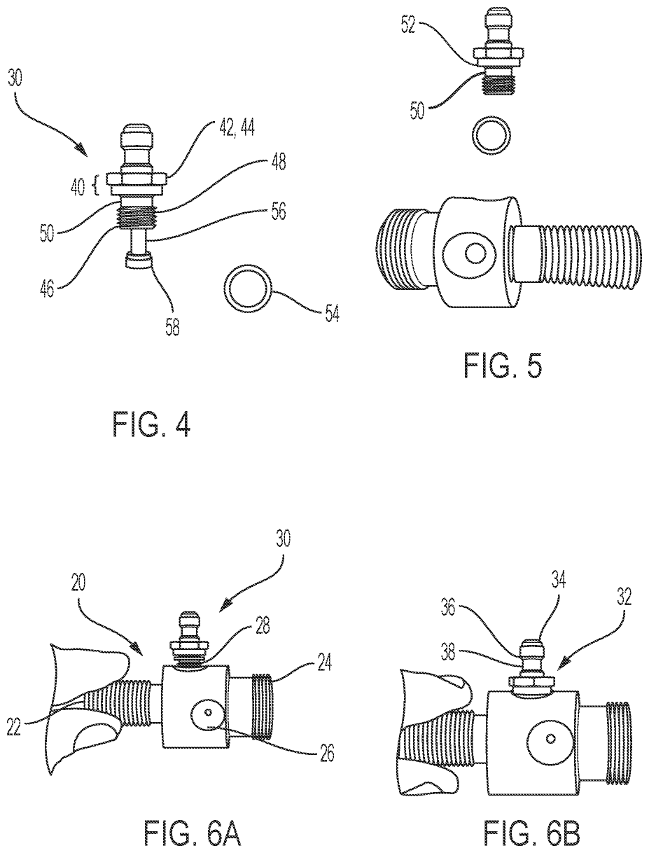

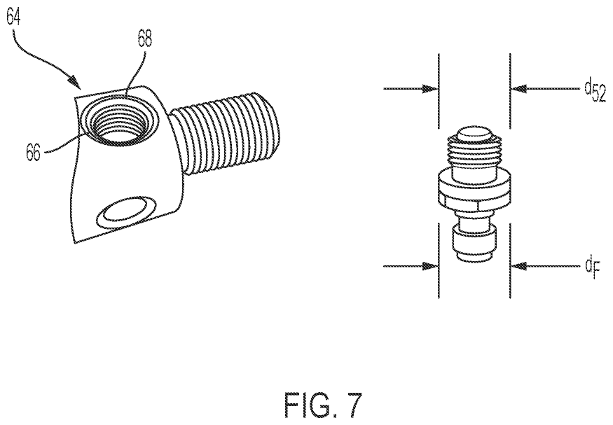

An embodiment of a fill nipple 30 according to the present disclosure for the regulator 20 is illustrated variously in FIGS. 2-6B. Referring to FIGS. 2, 3A and 3B, the fill nipple 30 includes a body 32 having a first end 34 having a standard quick connect (QC) fitting 36 to which a fill hose (via a connector) is connected. The fill hose and connector are well known components and as such are not shown. The QC fitting 36 is a cylindrical projection having a circumferential recess 38 onto which the fill hose connector locks.

At about a mid-body region 40, the fill nipple 30 includes a tightening element 42 for grasping the nipple 30 to tighten the nipple 30 onto the regulator 20. In embodiments, as illustrated in FIG. 2, the tightening element 42 includes a fitting 44 having a hex nut shape and size to grasp and tighten the nipple 30 onto the regulator 20.

A second end 46 of the fill nipple 30 (opposite the QC connection end 36) includes a threaded region 48 that extends from the second end 46 to threadedly engage the regulator 20. Unlike known fill nipples, the thread 48 extends from the second end 46 to a location spaced from the mid-body region 40 to define a gap 50 between the mid-body region 40 and the thread 48. The gap 50 has a smaller diameter d₅₀ than the thread crest diameter dc and has a diameter d₅₀ smaller than or equal to the thread root diameter d_{R}. In a current embodiment, the gap 50 has a smaller diameter d₅₀ than the thread root diameter d_{R}.

A part of the mid-body region 40 includes a stepped region 52. The stepped region 52 is adjacent to the tightening fitting 44, and between the tightening fitting 44 and the gap 50. In a current embodiment, the stepped region 52 is circular and has a diameter d₅₂ greater than the gap diameter d₅₀ and thread crest diameter dc. In an embodiment, the stepped region 52 has a diameter d₅₂ about equal to or just slightly smaller than the distance d_{F} across the flats 53 of the hex tightening fitting 44.

An O-ring 54 is positioned in the gap 50. The O-ring 54 fits snugly in the gap 50, adjacent to the stepped region 52. As with the prior known fill nipple 1, the present nipple 30 includes a strut 56 and O-ring 58 that reciprocate in the nipple 30 to allow and isolate the flow of gas through the nipple 30 during and following a fill cycle.

In embodiments, a regulator 20 that is configured to accept the self-sealing fill nipple 30 has a high pressure inlet 22 and a regulated pressure outlet 24. The regulator 20 has an O-ring seat 64 that, in a present embodiment, is formed as circular recess 66 in the fill port 28 into which the fill nipple 30 is threaded. The O-ring seat 64 is formed in the fill port 28 such that the O-ring 54 fully seats 360 degrees in the seat 64. The present recess 66 includes a flat surface 68 to provide a full, 360 degree seat and seal. In this manner, when the fill nipple 30 is threaded into the fill port 28, the nipple/fill port 30/28 interface forms a complete seal when, for example, filling the local tank. That is, the nipple 30 seals on the O-ring 54, rather than sealing on the threads. It is anticipated that the present self-sealing fill nipple 30 can be hand tightened onto the regulator 20 to seal the nipple 30 when filling the local tank and that the use of tools may not be required.

In a current embodiment, the thread 48 on the fill nipple 30 for threading into the regulator 20 and the regulator thread is a ⅜ inch 24 UNF-2A (Unified National Fine Thread) thread. It will be appreciated that UNF threads are straight, compared to NPT threads which are tapered, and that UNF threads are fine, rather than coarse, and that such UNF threads thus provide for a more positive or better seal. Other suitable thread sizes and forms are anticipated, will be appreciated by those skilled in the art, and are within the scope and spirit of the present disclosure.

In the present disclosure, the words “a” or “an” are to be taken to include both the singular and the plural. Conversely, any reference to plural items shall, where appropriate, include the singular. All patents and published applications referred to herein are incorporated by reference in their entirety, whether or not specifically done so within the text of this disclosure.

It will also be appreciated by those skilled in the art that any relative directional terms such as sides, upper, lower, top, bottom, rearward, inboard, forward, outboard and the like may be for explanatory purposes only and may not be intended to limit the scope of the disclosure.

From the foregoing it will be observed that numerous modifications and variations can be made without departing from the true spirit and scope of the novel concepts of the present disclosure. It is to be understood that no limitation with respect to the specific embodiments illustrated is intended or should be inferred.

1. A self-sealing fill nipple for a pressure regulator having a fill port, comprising:
a body having:
a first end having a quick connect fitting;
a mid-body region; and
a threaded region for threadedly engaging the pressure regulator at the fill port, the threaded region extending from about an end of the body toward the mid-body region and spaced therefrom by a gap, the threaded region having a crest diameter and a root diameter,
wherein the mid-body region includes a tightening element proximal the quick connect fitting and a gap between the tightening element and the threaded region, the gap having a diameter equal to or less than the threaded region root diameter.

2. The fill nipple of claim 1 wherein the gap is configured for receipt of a seal.

3. The fill nipple of claim 1, wherein the mid-body region further includes a stepped region between the tightening element and the gap.

4. The fill nipple of claim 3, wherein the stepped region is circular.

5. The fill nipple of claim 1, wherein the tightening element is a hexagonal shaped region.

6. The fill nipple of claim 5, wherein the mid-body region further includes a circular stepped region between the tightening element and the gap, and wherein the stepped region has a diameter less than or equal to a distance across opposing flats of the hexagonal shaped region.

7. The fill nipple of claim 1, wherein the threaded region has UNF thread.

8. The fill nipple of claim 7, wherein the threaded region has a ⅜ inch 24 UNF-2A thread.

9. In combination:
a pressure regulator having a fill port; and
a self-sealing fill nipple for the pressure regulator having a fill port, the fill nipple having:
a body having:
a first end having a quick connect fitting;
a mid-body region; and
a threaded region for threaded engagement with the pressure regulator at the fill port, the threaded region extending from about an end of the body toward the mid-body region and spaced therefrom by a gap, the threaded region having a crest diameter and a root diameter,
wherein the mid-body region includes a tightening element proximal the quick connect fitting and a gap between the tightening element and the threaded region, the gap having a diameter equal to or less than the threaded region root diameter.

10. The combination of claim 9, further including a seal on the fill nipple at the gap.

11. The combination of claim 10, wherein the seal is an O-ring.

12. The combination of claim 9, wherein the regulator has an O-ring seat at the fill port.

13. The combination of claim 12, wherein the O-ring seat is a flat recessed are surrounding the fill port.

14. The combination of claim 9, wherein the pressure regulator fill port has a UNF thread, and wherein the self-sealing fill nipple threaded region has a UNF thread for threaded engagement with the pressure regulator UNF thread.

15. The combination of claim 14, wherein the fill nipple threaded region and the fill port have complimentary ⅜ inch 24 UNF-2A threads.
